(19) United States
(12) Patent Application Publication
(10) Pub. No.: US 2011/0021099 A1
(43) Pub. Date: Jan. 27, 2011

(54) FLUORINE-CONTAINING POLYMER AND WATER-AND OIL-REPELLENT AGENT

(76) Inventors: Hisako Nakamura, Osaka (JP); Mitsuhiro Usugaya, Osaka (JP); Ryousuke Hara, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 12/934,221

(22) PCT Filed: Mar. 27, 2009
(86) PCT No.: PCT/JP2009/056917

§ 371 Date: Sep. 23, 2010

(51) Int. Cl. B32B 27/04; C08F 220/22

(52) U.S. Cl. 442/80; 526/245

(57) ABSTRACT

A water- and oil-repellent agent is an aqueous emulsion containing a fluorine-containing polymer. The fluorine-containing polymer comprises (a) a fluorine-containing monomer, and (b) a crosslinkable monomer, wherein the monomers (a) and (b) are polymerized in the presence of a chain transfer agent to produce the fluorine-containing polymer.

### CROSS-REFERENCE TO RELATED APPLICATIONS

This Application claims benefit under 35 U.S.C.§119(e) of U.S. Provisional Application No. 61/040,567 filed Mar. 28, 2008, incorporated herein by reference in its entirety.

### TECHINICAL FIELD

The present invention relates to a fluorine-containing polymer and a water- and oil-repellent agent.

### BACKGROUND ART

The fluorine-containing polymer is widely used for treatment to give the water- and oil-repellency and the water pressure resistance to textiles. JP-A-50-003438 and JP-A-63-090588 disclose a fluorine-containing polymer providing the water- and oil-repellency. It is desirable to lower a treatment temperature as much as possible to treat the textiles with the fluorine-containing polymer with less energy and lower cost. There was, however, the problem that water- and oil-repellency is deteriorated when the treatment temperature is lowered.

### DISCLOSURE OF THE INVENTION

### Problems to be Solved by the Invention

An object of the present invention is to provide the water- and oil-repellent agent which has good film formability and which imparts high performances (for example, water- and oil-repellency) at the low temperature.

Another object of the present invention is to provide a water- and oil-repellent agent which can treat at a wide treatment temperature range, and can have high performances (for example, water- and oil-repellency) obtained even at low treatment temperature.

### Means for Solving the Problems

The present invention provides a fluorine-containing polymer comprising:
(a) a fluorine-containing monomer, and
(b) a crosslinkable monomer,
   wherein the monomers (a) and (b) are polymerized in the presence of a chain transfer agent to produce the fluorine-containing polymer.

In addition, the present invention provides a water- and oil-repellent agent comprising the fluorine-containing polymer. Generally, the water- and oil-repellent agent consists of an aqueous emulsion comprising:
(I) the above-mentioned fluorine-containing polymer,
(II) a surfactant, and
(III) an aqueous medium.

The fluorine-containing polymer of the present invention functions as an active ingredient of the water- and oil-repellent agent.

### Effects of the Invention

The fluorine-containing polymer of the present invention has good film formability, and is excellent in the performance (for example, water- and oil-repellency, water pressure resistance, IPR (Water Impact Penetration Resistance)) when even treated at a low temperature.

In addition, the fluorine-containing polymer of the present invention has high performances (for example, water- and oil-repellency) without depending on a treatment temperature (even at a low temperature).

### BRIEF DESCRIPTION OF DRAWINGS

FIG. 1 shows relationship of a complex viscosity with a treatment temperature of the polymers prepared in Preparative Example 1 and Comparative Preparative Example 1.

FIG. 2 shows relationship of a complex viscosity with a treatment temperature of the polymers prepared in Preparative Examples 1 and 2 Comparative Preparative Example 1.

### MODE OF CARRYING OUT THE INVENTION

Preferably, the fluorine-containing polymer of the present invention has the complex viscosity of at most 3000 Pa-s at 70° C. and contains the crosslinkable monomer in the amount of at least 2% by weight based on the fluorine-containing polymer. Preferably, the complex viscosity is from 500 to 2,950 Pa-s, for example, from 1,000 to 2,900 Pa-s, particularly from 1,500 to 2,900 Pa-s.

The fluorine-containing polymer comprises the repeating units derived from the monomers (a) and (b), and optionally other monomer(s).

The fluorine-containing monomer is preferably of the general formula:

CH₂═C(—X)—C(═O)—Y—Z—Rf (1)
wherein X is a hydrogen atom, an alkyl group having 1 to 21 carbon atoms, a fluorine atom, a chlorine atom, a bromine atom, a iodine atom, a CFX¹X² group (wherein X¹ and X² is a hydrogen atom, a fluorine atom, a chlorine atom, a bromine atom or a iodine atom), a cyano group, a linear or branched fluoroalkyl group having 1 to 21 carbon atoms, a substituted or unsubstituted benzyl group, or a substituted or unsubstituted phenyl group;
Y is —O— or —NH—;
Z is an aliphatic group having 1 to 10 carbon atoms, an aromatic or cycloaliphatic group having 6 to 18 carbon atoms, a —CH₂CH₂N(R¹)SO₂— group (in which R¹ is an alkyl group having 1 to 4 carbon atoms), a —CH₂CH(OZ¹)CH₂— group (in which Z¹ is a hydrogen atom or an acetyl group), a —(CH₂)ₘ—SO₂—(CH₂)ₙ— group or a —(CH₂)ₘ—S—(CH₂)ₙ— group where m is 1 to 10 and n is 0 to 10; and
Rf is a linear or branched fluoroalkyl group having 1 to 21 carbon atoms.

In the fluorine-containing monomer (a), alpha-position (of acrylate or methacrylate) may be substituted with a group such as a halogen atom. Accordingly, in the formula (1), the X group may be a linear or branched alkyl group having 2 to 21 carbon atoms, a fluorine atom, a chlorine atom, a bromine atom, a iodine atom, a CFX¹X² group (wherein X¹ and X² is a hydrogen atom, a fluorine atom, a chlorine atom, a bromine atom or a iodine atom), a cyano group, a linear or branched fluoroalkyl group having 1 to 21 carbon atoms, a substituted or unsubstituted benzyl group, or a substituted or unsubstituted phenyl group.

Preferred examples of the Z group include an alkylene group having 1 to 10 carbon atoms, namely —(CH₂)ₙ— wherein n is from 1 to 10, preferably from 1 to 4.

In the formula (I), the Rf group is preferably a perfluoroalkyl group. The number of the carbon atoms in the Rf group is from 1 to 21, usually from 1 to 12, generally from 1 to 10, for example, from 1 to 8, particularly from 1 to 6, especially from 4 to 6. Examples of the Rf group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂, —(CF₂)₇CF₃, —(CF₂)₅CF(CF₃)₂, —(CF₂)₆CF(CF₃)₂ and —(CF₂)₉CF₃.

Specific examples of the component (a) are the followings, to which the present invention is not limited.
CH₂═C(—H)—C(═O)—O—(CH₂)₂—Rf
CH₂═C(—H)—C(═O)—O—C₆H₄—Rf
CH₂═C(—Cl)—C(═O)—O—(CH₂)₂—Rf
CH₂═C(—H)—C(═O)—O—(CH₂)₂N (—CH₃)SO₂—Rf
CH₂═C(—H)—C(═O)—O—(CH₂)₂N (—C₂H₅)SO₂—Rf
CH₂═C(—H)—C(═O)—O—CH₂CH(—OH)CH₂—Rf
CH₂═C(—H)—C(═O)—O—CH₂CH(—OCOCH₃)CH₂—Rf
CH₂═C(—H)—C(═O)—O—(CH₂)₂—S—Rf
CH₂═C(—H)—C(═O)—O—(CH₂)₂—S—(CH₂)₂—Rf
CH₂═C(—H)—C(═O)—O—(CH₂)₃—SO₂—Rf
CH₂═C(—H)—C(═O)—O—(CH₂)₂—SO₂—(CH₂)₂—Rf
CH₂═C(—H)—C(═O)—NH—(CH₂)₂—Rf
CH₂═C(—CH₃)—C(═O)—O—(CH₂)₂—S—Rf
CH₂═C(—CH₃)—C(═O)—O—(CH₂)₂—S—(CH₂)₂—Rf
CH₂═C(—CH₃)—C(═O)—O—(CH₂)₃—SO₂—Rf
CH₂═C(—CH₃)—C (═O)—O—(CH₂)₂—SO₂—(CH₂)₂—Rf
CH₂═C(—CH₃)—C (═O)—NH—(CH₂)₂—Rf
CH₂═C(—F)—C(═O)—O—(CH₂)₂—S—Rf
CH₂═C(—F)—C(═O)—O—(CH₂)₂—S—(CH₂)₂—Rf
CH₂═C(—F)—C(═O)—O—(CH₂)₂—SO₂—Rf
CH₂═C(—F)—C(═O) —O—(CH₂)₂—SO₂—(CH₂)₂—Rf
CH₂═C(—F)—C(═O)—NH—(CH₂)₂—Rf
CH₂═C(—Cl)—C(═O)—O—(CH₂)₂—S—Rf
CH₂═C(—Cl)—C(═O)—O—(CH₂)₂—S—(CH₂)₂—Rf
CH₂═C(—Cl)—C(═O)—O—(CH₂)₂—SO₂—Rf
CH₂═C(—Cl)—C(═O)—O—(CH₂)₂—SO₂—(CH₂)₂—Rf
CH₂═C(—Cl)—C(═O)—NH—(CH₂)₂—Rf
CH₂═C(—CF₃)—C(═O)—O—(CH₂)₂—S—Rf
CH₂═C(—CF₃)—C(═O)—O—(CH₂)₂—S—(CH₂)₂—Rf
CH₂═C(—CF₃)—C(═O)—O—(CH₂)₂—SO₂—Rf
CH₂═C(—CF₃)—C(═O)—O—(CH₂)₂—SO₂—(CH₂)₂—Rf
CH₂═C(—CF₃)—C(═O)—NH—(CH₂)₂—Rf
CH₂═C(—CF₂H)—C(═O)—O—(CH₂)₂—S—Rf
CH₂═C(—CF₂H)—C(═O)—O—(CH₂)₂—S—(CH₂)₂—Rf
CH₂═C(—CF₂H)—C(═O)—O—(CH₂)₂—SO₂—Rf
CH₂═C(—CF₂H)—C(═O)—O—(CH₂)₂—SO₂—(CH₂)₂—Rf
CH₂═C(—CF₂H)—C(═O)—NH—(CH₂)₂—Rf
CH₂═C(—CN)—C(═O)—O—(CH₂)₂—S—Rf
CH₂═C(—CN)—C(═O)—O—(CH₂)₂—S—(CH₂)₂—Rf
CH₂═C(—CN)—C(═O)—O—(CH₂)₂—SO₂—Rf
CH₂═C(—CN)—C(═O)—O—(CH₂)₂—SO₂—(CH₂)₂—Rf
CH₂═C(—CN)—C(═O)—NH—(CH₂)₂—Rf
CH₂═C(—CF₂CF₃)—C(═O)—O—(CH₂)₂—S—Rf
CH₂═C(—CF₂CF₃)—C(═O)—O—(CH₂)₂—S—(CH₂)₂—Rf
CH₂═C(—CF₂CF₃)—C(═O)—O—(CH₂)₂—SO₂—Rf
CH₂═C(—CF₂CF₃)—C(═O)—O—(CH₂)₂—SO₂—(CH₂)₂—Rf
CH₂═C(—CF₂CF₃)—C(═O)—NH—(CH₂)₂—Rf
CH₂═C(—F)—C(═O)—O—(CH₂)₃—S—Rf
CH₂═C(—F)—C(═O)—O—(CH₂)₃—S—(CH₂)₂—Rf
CH₂═C(—F)—C(═O)—O—(CH₂)₃—SO₂—Rf
CH₂═C(—F)—C(═O)—O—(CH₂)₃—SO₂—(CH₂)₂—Rf
CH₂═C(—F)—C(═O)—NH—(CH₂)₃—Rf
CH₂═C(—Cl)—C(═O)—O—(CH₂)₃—S—Rf
CH₂═C(—Cl)—C(═O)—O—(CH₂)₃—S—(CH₂)₂—Rf
CH₂═C(—Cl)—C(═O)—O—(CH₂)₃—SO₂—Rf
CH₂═C(—Cl)—C(═O)—O—(CH₂)₃—SO₂—(CH₂)₂—Rf
CH₂═C(—CF₃)—C(═O)—O—(CH₂)₃—S—Rf
CH₂═C(—CF₃)—C(═O)—O—(CH₂)₃—S—(CH₂)₂—Rf
CH₂═C(—CF₃)—C(═O)—O—(CH₂)₃—SO₂—Rf
CH₂═C(—CF₃)—C(═O)—O—(CH₂)₃—SO₂—(CH₂)₂—Rf
CH₂═C(—CF₂H)—C(═O)—O—(CH₂)₃—S—Rf
CH₂═C(—CF₂H)—C(═O)—O—(CH₂)₃—S—(CH₂)₂—Rf
CH₂═C(—CF₂H)—C(═O)—O—(CH₂)₃—SO₂—Rf
CH₂═C(—CF₂H)—C(═O)—O—(CH₂)₃—SO₂—(CH₂)₂—Rf
CH₂═C(—CN)—C(═O)—O—(CH₂)₃—S—Rf
CH₂═C(—CN)—C(═O)—O—(CH₂)₃—S—(CH₂)₂—Rf
CH₂═C(—CN)—C(═O)—O—(CH₂)₃—SO₂—Rf
CH₂═C(—CN)—C(═O)—O—(CH₂)₃—SO₂—(CH₂)₂—Rf
CH₂═C(—CF₂CF₃)—C(═O)—O—(CH₂)₃—S—Rf
CH₂═C(—CF₂CF₃)—C(═O)—O—(CH₂)₃—S—(CH₂)₂—Rf
CH₂═C(—CF₂CF₃)—C(═O)—O—(CH₂)₃—SO₂—Rf
CH₂═C(—CF₂CF₃)—C(═O)—O—(CH₂)₂—SO₂—(CH₂)₂—Rf
   wherein Rf is a fluoroalkyl group having 1 to 21, particularly 1 to 6 carbon atoms.

The monomer (a) may be a mixture of at least two.

The fluorine-containing polymer contains the crosslinkable monomer (b). The crosslinkable monomer may be a fluorine-free monomer having at least two reactive groups and/or carbon-carbon double bonds. The crosslinkable monomer may be a compound having at least two carbon-carbon double bonds, or a compound having at least one carbon-carbon double bond and at least one reactive group. Examples of the reactive group include a hydroxyl group, an epoxy group, a chloromethyl group, a blocked isocyanate group, an amino group and a carboxyl group.

The monomer (b) may be a mixture of at least two. The crosslinkable monomer (b) may be a combination of a monomer having an epoxy group and a monomer having a hydroxyl group (Preferable weight ratio is 2:98 to 90:10).

Examples of the crosslinkable monomer (b) include diacetone(meth)acrylamide, (meth)acrylamide, N-methylol(meth)acrylamide, hydroxymethyl (meth)acrylate, hydroxyethyl (meth)acrylate, 3-chloro-2-hydroxypropyl (meth)acrylate, N,N-dimethylaminoethyl (meth)acrylate, N,N-diethylaminoethyl (meth)acrylate, butadiene, chloroprene and glycidyl (meth)acrylate, to which the crosslinkable monomer is not limited.

Other examples of the crosslinkable monomer include glycerol (meth)acrylate, acetoacetoxyethyl (meth)acrylate, isocyanate group-containing (meth)acrylates such as 2-isocyanatoethyl (meth)acrylate, and these (meth)acrylates having an isocyanate group blocked with a blocking agent such as methyl ethyl ketoxime.

The crosslinkable monomer causes the fluorine-containing polymer to be hard when treated even at a low temperature and to have high performances.

In general, the fluorine-containing polymer of the present invention comprises only the monomers (a) and (b). The fluorine-containing polymer may contain (c) a monomer other than the monomers (a) and (b). The other monomer (c) is preferably a non-crosslinkable monomer.

The non-crosslinkable monomer is preferably a fluorine-free monomer having a carbon-carbon double bond. The non-crosslinkable monomer is preferably a vinyl monomer which is free from fluorine. Generally the non-crosslinkable monomer is a compound having one carbon-carbon double bond.

Examples of the non-crosslinkable monomer include butadiene, chloroprene, maleic acid derivatives, vinyl halide such as vinyl chloride, ethylene, vinylidene halide such as vinylidene chloride, vinyl alkyl ether, styrene, alkyl (meth)acrylate and vinyl pyrrolidone, but are not limited to these.

The non-crosslinkable monomer may be a (meth)acrylate ester having an alkyl group. The number of carbon atoms of the alkyl group may be from 1 to 30, for example, from 6 to 30, e.g., from 10 to 30. For example, the fluorine atom-free monomer may be acrylates of the general formula:

CH₂═CA¹COOA²

wherein A¹ is a hydrogen atom or a methyl group, and A² is an alkyl group represented by CₙH₂ₙ₊₁ (n=1 to 30).

The other monomer (c) may be a mixture of at least two.

The fluorine-containing polymer contains 100 parts by weight of the fluorine-containing monomer (a). The amount of the crosslinkable monomer (b) is from 2 to 30 parts by weight, for example, from 3 to 15 parts by weight, particularly from 3 to 10 parts by weight, and the amount of other monomer (c) is at most 150 parts by weight, for example, from 5 to 100 parts by weight, particularly from 30 to 80 parts by weight, based on 100 parts by weight of fluorine-containing monomer (a).

The polymer of the present invention may be a random copolymer or a block copolymer.

The weight-average molecular weight of the polymer of the present invention may be from 1,000 to 1,000,000, preferably from 5,000 to 500,000. The molecular weight is measured by a gel permeation chromatography in terms of polystyrene.

A polymerization method of producing the polymer of the present invention is not limited. Various polymerization methods such as a bulk polymerization, a solution polymerization, an emulsion polymerization and a radiation polymerization can be selected. For example, a solution polymerization using an organic solvent and an emulsion polymerization using water alone or both an organic solvent and water are generally selected. A treatment liquid can be produced by diluting a reaction mixture with water after the polymerization or by adding an emulsifier to make the emulsification in water.

Examples of the organic solvent include ketones such as acetone and methyl ethyl ketone; esters such as ethyl acetate and methyl acetate; glycols such as propylene glycol, dipropylene glycol monomethyl ether, dipropylene glycol, tripropylene glycol and polyethylene glycol preferably having low-molecular weight; and alcohols such as ethyl alcohol and isopropanol.

Various emulsifiers such as conventional anionic, cationic or nonionic emulsifiers can be used as the emulsifier added for the emulsion polymerization or added after the polymerization for giving an emulsion in water.

A polymerization initiator such as a peroxide compound, an azo compound and a persulfate compound can be used. Generally, the polymerization initiator is water-soluble and/or oil-soluble.

Preferred specific example of the oil-soluble polymerization initiator include 2,2′-azobis(2-methyl propionitrile), 2,2′-azobis(2-methyl butyronitrile), 2,2′-azobis(2,4-dimethyl valeronitrile), 2,2′-azobis(2,4-dimethyl-4-methoxyvaleronitrile), 1,1′-azobis(cyclohexane-1-carbonitrile), dimethyl-2,2′-azobis(2-methyl propionate), 2,2′-azobis(2-isobutyronitrile), benzoyl peroxide, di-tert.-butyl peroxide, lauryl peroxide, cumene hydro-peroxide, t-butyl peroxypivalate, diisopropyl peroxydicarbonate, and t-butyl perpivalate.

In addition, preferred specific examples of the water-soluble polymerization initiator include 2,2′-azobisisobutylamidine dihydrochloride, 2,2′-azobis(2-methylpropionamidine) hydrochloride, 2,2′-azobis[2-(2-imidazolin-2-yl)-propane] hydrochloride, 2,2′-azobis[2-(2-imidazolin-2-yl) propane] sulfate salt hydrate, 2,2′-azobis[2-(5-methyl-2-imidazolin-2-yl)propane] hydrochloride, potassium persulfate, barium persulfate, ammonium persulfate and hydrogen peroxide.

The polymerization initiator may be used in the amount within the range from 0.01 to 5 parts by weight, based on 100 parts by weight of the monomers.

In the present invention, the chain transfer agent is used for polymerization. The chain transfer agent gives good film formability of the fluorine-containing polymer and improves the performances at the low temperature. The chain transfer agent is preferably an alkyl mercaptan. In the alkyl mercaptan, the number of the carbon atoms of the alkyl group is preferably from 4 to 18, for example, from 6 to 12. The number of the carbon atoms of the alkyl group is particularly preferably at most than 8. The amount of the chain transfer agent may be from 0.1 to 10 parts by weight, for example, from 0.2 to 5 parts by weight, particularly from 0.2 to 2 parts by weight, based on 100 parts by weight of the monomer.

Specifically, the polymer can be prepared as follows:

In a solution polymerization, there can be used a method of dissolving the monomer(s) into an organic solvent in the presence of a polymerization initiator and the chain transfer agent, replacing the atmosphere by nitrogen, and stirring the mixture with heating at the temperature within the range from 50° C. to 120° C. for 1 hour to 10 hours. Generally a polymerization initiator may be an oil-solubility polymerization initiator. The organic solvent is inert to the monomer and can solubilize the monomer. Examples of the organic solvent include ketones such as acetone and methyl ethyl ketone; esters such as ethyl acetate and methyl acetate; glycols such as propylene glycol, dipropylene glycol monomethyl ether, dipropylene glycol, tripropylene glycol and polyethylene glycol preferably having low-molecular weight; and alcohols such as ethyl alcohol and isopropanol.

The organic solvent may be used in the amount within the range from 50 to 1,000 parts by weight, based on 100 parts by weight of total of the monomers.

In an emulsion polymerization, there can be used a method of emulsifying monomers in water in the presence of a polymerization initiator, an emulsifier and the chain transfer agent, replacing the atmosphere by nitrogen, and polymerizing with stirring, for example, at the temperature within the range from 50° C. to 80° C. for 1 hour to 10 hours. The polymerization initiator may be water-soluble polymerization initiator and/or an oil-soluble polymerization initiator.

In order to obtain a polymer dispersion in water, which is superior in storage stability, it is desirable that the monomers are finely emulsified in water by using an emulsifier capable of applying a strong shear energy (e.g., a high-pressure homogenizer and an ultrasonic homogenizer) and then polymerized with using the water-soluble polymerization initiator.

As the emulsifier, various emulsifiers such as an anionic emulsifier, a cationic emulsifier and a nonionic emulsifier can be used in the amount within the range from 0.5 to 20 parts by weight, for example, 1 to 10 parts by weight, based on 100 parts by weight of the monomers.

When the monomers are not completely compatibilized, a compatibilizing agent (e.g., a water-soluble organic solvent and a low-molecular weight monomer) capable of sufficiently compatibilizing them is preferably added to these monomers. By the addition of the compatibilizing agent, the emulsifiability and polymerizability can be improved.

Examples of the water-soluble organic solvent include acetone, methyl ethyl ketone, ethyl acetate, propylene glycol, dipropylene glycol monomethyl ether, dipropylene glycol, tripropylene glycol and ethanol. The water-soluble organic solvent may be used in the amount within the range from 1 to 80 parts by weight, e.g., from 5 to 50 parts by weight, based on 100 parts by weight of water. Examples of the low-molecular weight monomer include methyl methacrylate, glycidyl methacrylate and 2,2,2-trifluoroethyl methacrylate. The low-molecular weight monomer may be used in the amount within the range from 1 to 50 parts by weight, e.g., from 10 to 40 parts by weight, based on 100 parts by weight of total of monomers.

The thus obtained polymer can be diluted or dispersed with water or an organic solvent if necessary, and then prepared in an arbitrary form such as an emulsion, a solution in an organic solvent and an aerosol to give the water- and oil-repellent agent. The polymer functions as an effective component (an active ingredient) of the water- and oil-repellent agent. The water- and oil-repellent agent comprises the fluorine-containing polymer and a medium (particularly a liquid medium) (for example, an organic solvent and/or water). The concentration of the fluorine-containing polymer in the water- and oil-repellent agent may be, for example, from 0.01 to 50% by weight, particularly from 10 to 40% by weight, based on the water- and oil-repellent agent.

The water- and oil-repellent agent of the present invention is preferably an aqueous emulsion comprising the fluorine-containing polymer, a surfactant and an aqueous medium. In the present specification, the “liquid medium” includes a medium consisting of water and a medium containing an organic solvent in addition to water (The amount of the organic solvent may be at most 80 parts by weight, for example, at most 80 parts by weight, particularly from 0.1 to 50 parts by weight, particularly from 5 to 30 parts by weight, based on 100 parts by weight of water.).

The surfactant in the aqueous emulsion may be any of a nonionic surfactant, an anionic surfactant, a cationic surfactant and an ampholytic surfactant.

Examples of the surfactant include the cationic surfactant alone, the ampholytic surfactant alone and the combination of cationic surfactant and the ampholytic surfactant (The weight ratio may be preferably from 99:1 to 70:30.).

Example of the nonionic surfactant include a glycerin fatty acid ester, a sorbitan fatty acid ester, a sucrose fatty acid ester, a polyoxyethylene alkyl ether, a polyoxyethylene alkyl phenyl ether, a polyoxyethylene polyoxypropylene glycol, a fatty acid polyethylene glycol, a fatty acid polyoxyethylene sorbitan and a fatty acid alkanolamide.

Examples of the anionic surfactants include an aliphatic monocarboxylate salt, a polyoxyethylene alkyl ether carboxylate salt, a N-acyl sarcosinate salt, a N-acyl glutamate salt, a dialkylsulfosuccinate salt, an alkanesulfonate salt, an alpha olefin sulfonate salt, a linear alkylbenzene sulfonate salt, a branched alkylbenzene sulfonate salt, a naphthalene sulfonate salt-formaldehyde condensate, an alkyl naphthalene sulfonate salt, a N-methyl-N-acyl taurine, an alkyl sulfate salt, a polyoxyethylene alkyl ether/sulfate salt, an alkyl phosphate salt, a polyoxyethylene alkyl ether phosphate salt, and a polyoxyethylene alkylphenylether phosphate salt.

Examples of the cationic surfactant include a monoalkylamine salt, a dialkyl amine salt, a trialkyl amine salt, trimethylammonium chloride (or bromide or iodide), dialkyldimethylammonium chloride (or bromide or iodide), alkylbenzyldimethylammonium chloride.

Examples of the ampholytic surfactant include an alkyl betaine, an alkyl sulfobetaine, a fatty acid amide propyl betaine, a 2-alkyl-N-carboxymethyl-N-hydroxyethyl imidazolium betaine, an alkyl (or dialkyl) diethylene tri aminoacetic acid, and an alkylamine oxide.

The amount of the surfactant may be from 1 to 20 parts by weight, particularly from 5 to 10 parts by weight, based on 100 parts by weight of the fluorine-containing polymer.

The polymer of the present invention can be applied to the treated article as the water- and oil-repellent agent by an arbitrary method, depending on a type of the treated article or a preparation form (such as an emulsion, an organic solvent solution and an aerosol). For example, when the water- and oil-repellent agent is the aqueous emulsion and the organic solvent solution, the water- and oil-repellent agent is adhered to surfaces of the substrate by a well-known procedure such as an immersion coating and a spray coating, and is dried. If necessary, a heat treatment such as curing may be conducted. The water- and oil-repellent agent is applied together with a suitable crosslinking agent, followed by heat treatment such as curing (for example, at 80-200° C. for 5 seconds to 1 hour).

If necessary, blenders (that is, additives) may be used in addition to the water- and oil-repellent agent of the present invention. It is also possible to add, to the water- and oil-repellent agent of the present invention, blenders such as other surface water- and oil-repellent agents (for example, a water repellent agent and an oil repellent agent), anti-wrinkle agents, anti-shrink agents, flame retardants, crosslinking agents, antistatic agents, softeners, water-soluble polymers such as polyethylene glycol and polyvinyl alcohol, wax emulsions, mothproofing agents, antimicrobial agents, pigments and paints. These blenders may be used by adding to a treatment bath when the article to be treated is treated, or, if possible, these blenders may be mixed with the polymer of the present invention beforehand.

For the immersion coating, the concentration of the fluorine-containing compound in the treatment liquid contacted with the substrate may be from 0.05 to 10% by weight, based on the treatment liquid. For the spray coating, the concentration of the fluorine-containing compound in the treatment liquid may be from 0.1 to 5% by weight, based on the treatment liquid.

The substrate to be treated with the water- and oil-repellent agent of the present invention is not limited and examples thereof include a textile, masonry, a filter (for example, an electrostatic filter), a dust protective mask, glass, paper, wood, leather, fur, asbestos, brick, cement, metal and oxide, ceramics, plastics, a coated surface and a plaster.

The present invention is particularly effective for the textile. The textile has various examples. Examples of the textile include animal- or vegetable-origin natural fibers such as cotton, hemp, wool and silk; synthetic fibers such as polyamide, polyester, polyvinyl alcohol, polyacrylonitrile, polyvinyl chloride and polypropylene; semi-synthetic fibers such as rayon and acetate; inorganic fibers such as glass fiber, carbon fiber and asbestos fiber; and a mixture of these fibers. The textile may be in any form such as a fiber, yarn and a fabric.

In the present invention, the substrate is treated with the water- and oil-repellent agent. The “treatment” means that the water- and oil-repellent agent is applied to the substrate by immersion, spraying, coating or the like. The treatment gives the result that the fluorine-containing polymer which is an active component of the water- and oil-repellent agent is penetrated into the internal parts of the substrate and/or adhered to surfaces of the substrate.

### EXAMPLES

The following Examples further illustrate the present invention in detail but are not to be construed to limit the scope thereof.

In the followings, parts or % is parts by weight or % by weight, unless otherwise specified.

The procedures of the tests are as follows:

### Shower Water Repellency Test:

Shower water repellency test was conducted according to JIS-L-1092. The shower water repellency was expressed by water repellency No. (as shown in the below-described Table 1). The suffix “+” attached to the numeral value means that the performance is slightly better than the performance indicated by said numeral value.

TABLE 1

| Water | |
|---|---|
| repellency | |
| No. | State |
| 100 | No wet or water droplets adhesion on surface |
| 90 | No wet but small water droplets adhesion on |
| | surface |
| 80 | Separate small water droplets-like |
| | wet on surface |
| 70 | Wet on half of surface and separate small wet |
| | which penetrates fabric |
| 50 | Wet on whole surface |
| 0 | Wet on front and back whole surfaces |

### Water-Repellency Test:

A treated fabric is stored in a thermo-hygrostat having a temperature of 21° C. and a humidity of 65% for at least 4 hours. A test liquid (isopropyl alcohol (IPA), water, and a mixture thereof, as shown in Table 2) which has been also stored at 21° C. is used. The test is conducted in an air-conditioned room having a temperature of 21° C. and a humidity of 65%. A droplet of the test liquid having an amount of 50 μL is softly dropped by a micropipette on the fabric. If the droplet remains on the fabric after standing for 30 seconds, the test liquid passes the test. The water-repellency is expressed by a point corresponding to a maximum content (% by volume) of isopropyl alcohol (IPA) in the test liquid which passes the test. The water-repellency is evaluated as twelve levels which are Fail, 0, 1, 2, 3, 4, 5, 6, 7, 8, 9 and 10 in order of a poor level to an excellent level.

TABLE 2
Water-repellency test liquid

| | (% by volume) | |
|---|---|---|
| Point | Isopropyl alcohol | Water |
| 10 | 100 | 0 |
| 9 | 90 | 10 |
| 8 | 80 | 20 |
| 7 | 70 | 30 |
| 6 | 60 | 40 |
| 5 | 50 | 50 |
| 4 | 40 | 60 |
| 3 | 30 | 70 |
| 2 | 20 | 80 |
| 1 | 10 | 90 |
| 0 | 0 | 100 |

| | |
|---|---|
| Fail | Inferior to isopropyl alcohol 0/water 100 |

### Oil-Repellency Test:

A treated fabric is stored in a thermo-hygrostat having a temperature of 21° C. and a humidity of 65% for at least 4 hours. A test liquid (shown in Table 3) which has been also stored at 21° C. is used. The test is conducted in an air-conditioned room having a temperature of 21° C. and a humidity of 65%. A droplet of the test liquid in an amount of 0.05 mL is softly dropped by a micropipette on the fabric. If the droplet remains on the fabric after standing for 30 seconds, the test liquid passes the test. The oil-repellency is expressed by a maximum point of the test liquid which passes the test. The oil-repellency is evaluated as nine levels which are Fail, 1, 2, 3, 4, 5, 6, 7 and 8 in order of a poor level to an excellent level.

TABLE 3
Oil-repellency test liquid

| | | Surface tension |
|---|---|---|
| Point | Test liquid | (dyne/cm, 25° C.) |
| 8 | n-Heptane | 20.0 |
| 7 | n-Octane | 21.8 |
| 6 | n-Decane | 23.5 |
| 5 | n-Dodecane | 25.0 |
| 4 | n-Tetradecane | 26.7 |
| 3 | n-Hexadecane | 27.3 |
| 2 | Mixture liquid of | 29.6 |
| | n-Hexadecane 35/nujol 65 | |
| 1 | Nujol | 31.2 |
| Fail | Inferior to 1 | — |

### Water Pressure Resistance Test:

In accordance with a water pressure resistance test method of AATCC 127-2003, a water pressure resistance is measured by using a water pressure resistance measurement apparatus.

### IPR (Water Impact Penetration Resistance) Test

The test is conducted in accordance with an AATCC Test Method 42-2000.

### Complex Viscosity Measurement:

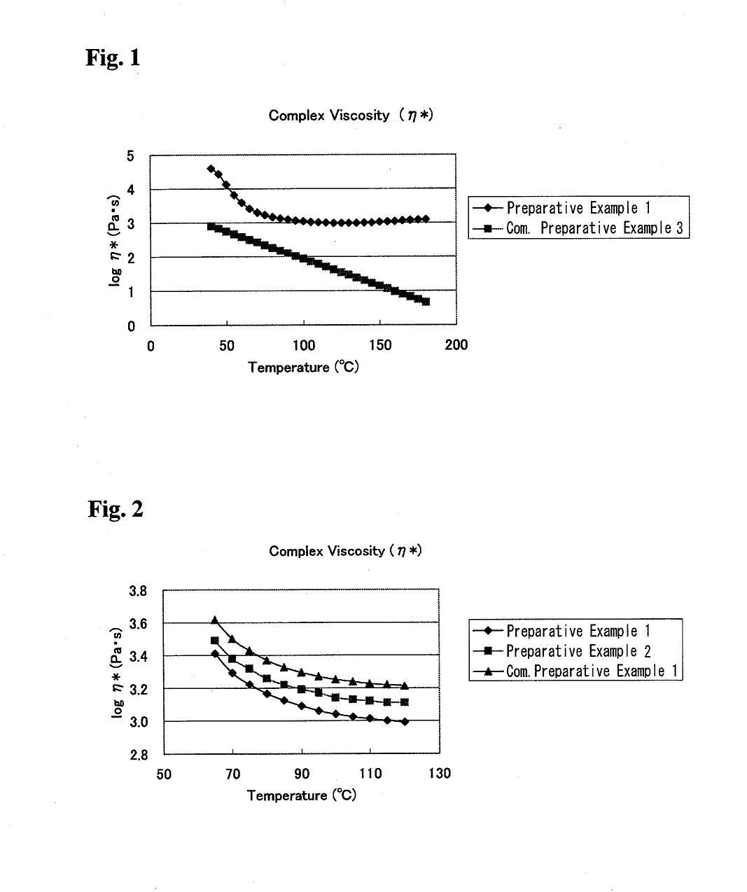

A dispersion of a fluorine-containing acrylic polymer water- and oil-repellent agent (10 g) in methanol (20 g) is applied to a centrifugal separation at 10,000 rpm for 60 minutes, and a fluorine-containing acrylic polymer is separated from an emulsifier to give a sample polymer for measurement. A complex viscosity (H*) of this polymer is measured in a dynamic viscoelasticity measurement apparatus RHEOSOL-G3000 (manufactured by UBM Co., Ltd.). The measurement result under a temperature rise of 5° C./min in a measurement temperature from 40° C. to 180° C. at a sample amount of 0.6 g and a frequency of 0.5 Hz is shown in FIG. 1. The measurement result under a temperature rise of 5° C./min in a measurement temperature from 40° C. to 180° C. at a sample amount of 0.8 g and a frequency of 0.5 Hz is shown in FIG. 2.

### Preparative Example 1

CF₃CF₂(CF₂CF₂)ₙCH₂CH₂COOCH═CH₂ (a mixture of compounds wherein n is 3, 4 and 5; average of n is 3.1) (160 g), stearyl acrylate (26 g), cyclohexyl methacrylate (52 g), glycidyl methacrylate (2.6 g), N-methylol acrylamide (10.9 g), 3-chloro-2-hydroxypropyl methacrylate (2.6 g), octyl mercaptan (0.1 g), (C₁₆-C₁₈)alkyltrimethylammonium chloride (20 g), lauryl dimethyl amine oxide (2 g), tripropylene glycol (42 g) and deionized water (480 g) were mixed to give a mixture. The mixture was heated to 60° C. and emulsified by a high pressure homogenizer. The resultant emulsion liquid was charged into a 300 mL flask, and nitrogen was replaced to remove the dissolved oxygen. Next, azobisamidinopropane dihydrochloride (0.5 g) was charged. The polymerization was conducted at 60° C. for three hours with stirring to give a copolymer emulsion. This emulsion was diluted with deionized water to give a fluorine-containing acrylic water- and oil-repellent agent (aqueous composition) having a solid content of 30% by weight. The composition of the resultant polymer was almost the same as the formulations of charged monomers.

The resultant polymer had a complex viscosity of 1,970 Pa-s at 70° C.

### Preparative Example 2

CF₃CF₂(CF₂CF₂)ₙCH₂CH₂COOCH═CH₂ (a mixture of compounds wherein n is 3, 4 and 5; average of n is 3.1) (160 g), stearyl acrylate (26 g), cyclohexyl methacrylate (52 g), glycidyl methacrylate (2.6 g), N-methylol acrylamide (10.9 g), 3-chloro-2-hydroxypropyl methacrylate (2.6 g), octyl mercaptan (0.05 g), (C₁₆-C₁₈)alkyltrimethylammonium chloride (20 g), lauryl dimethyl amine oxide (2 g), tripropylene glycol (42 g) and deionized water (480 g) were mixed to give a mixture. The mixture was heated to 60° C. and emulsified by a high pressure homogenizer. The resultant emulsion liquid was charged into a 300 mL flask, and nitrogen was replaced to remove the dissolved oxygen. Next, azobisamidinopropane dihydrochloride (0.5 g) was charged. The polymerization was conducted at 60° C. for three hours with stirring to give a copolymer emulsion. This emulsion was diluted with deionized water to give a fluorine-containing acrylic water- and oil-repellent agent (aqueous composition) having a solid content of 30% by weight. The composition of the resultant polymer was almost the same as the formulations of charged monomers.

The resultant polymer had a complex viscosity of 2,840 Pa-s at 70° C.

### Comparative Preparative Example 1

CF₃CF₂(CF₂CF₂)ₙCH₂CH₂COOCH═CH₂ (a mixture of compounds wherein n is 3, 4 and 5; average of n is 3.1) (160 g), stearyl acrylate (26 g), cyclohexyl methacrylate (52 g), glycidyl methacrylate (2.6 g), N-methylol acrylamide (10.9 g), 3-chloro-2-hydroxypropyl methacrylate (2.6 g), octyl mercaptan (0.025 g), (C₁₆-C₁₈)alkyltrimethylammonium chloride (20 g), lauryl dimethyl amine oxide (2 g), tripropylene glycol (42 g) and deionized water (480 g) were mixed to give a mixture. The mixture was heated to 60° C. and emulsified by a high pressure homogenizer. The resultant emulsion liquid was charged into a 300 mL flask, and nitrogen was replaced to remove the dissolved oxygen. Next, azobisamidinopropane dihydrochloride (0.5 g) was charged. The polymerization was conducted at 60° C. for three hours with stirring to give a copolymer emulsion. This emulsion was diluted with deionized water to give a fluorine-containing acrylic water- and oil-repellent agent (aqueous composition) having a solid content of 30% by weight. The composition of the resultant polymer was almost the same as the formulations of charged monomers.

The resultant polymer had a complex viscosity of 3,170 Pa-s at 70° C.

### Comparative Preparative Example 2

CF₃CF₂(CF₂CF₂)ₙCH₂CH₂COOCH═CH₂ (a mixture of compounds wherein n is 3, 4 and 5; average of n is 3.1) (160 g), stearyl acrylate (26 g), cyclohexyl methacrylate (52 g), glycidyl methacrylate (2.6 g), N-methylol acrylamide (10.9 g), 3-chloro-2-hydroxypropyl methacrylate (2.6 g), octyl mercaptan (0.01 g), (C₁₆-C₁₈)alkyltrimethylammonium chloride (20 g), lauryl dimethyl amine oxide (2 g), tripropylene glycol (42 g) and deionized water (480 g) were mixed to give a mixture. The mixture was heated to 60° C. and emulsified by a high pressure homogenizer. The resultant emulsion liquid was charged into a 300 mL flask, and nitrogen was replaced to remove the dissolved oxygen. Next, azobisamidinopropane dihydrochloride (0.5 g) was charged. The polymerization was conducted at 60° C. for three hours with stirring to give a copolymer emulsion. This emulsion was diluted with deionized water to give a fluorine-containing acrylic water- and oil-repellent agent (aqueous composition) having a solid content of 30% by weight. The composition of the resultant polymer was almost the same as the formulations of charged monomers.

### Comparative Preparative Example 3

CF₃CF₂(CF₂CF₂)ₙCH₂CH₂COOCH═CH₂ (a mixture of compounds wherein n is 3, 4 and 5; average of n is 3.1) (160 g), stearyl acrylate (26 g), cyclohexyl methacrylate (52 g), octyl mercaptan (0.1 g), (C₁₆-C₁₈)alkyltrimethylammonium chloride (20 g), lauryl dimethyl amine oxide (2 g), tripropylene glycol (42 g) and deionized water (480 g) were mixed to give a mixture. The mixture was heated to 60° C. and emulsified by a high pressure homogenizer. The resultant emulsion liquid was charged into a 300 mL flask, and nitrogen was replaced to remove the dissolved oxygen. Next, azobisamidinopropane dihydrochloride (0.5 g) was charged. The polymerization was conducted at 60° C. for three hours with stirring to give a copolymer emulsion. This emulsion was diluted with deionized water to give a fluorine-containing acrylic water- and oil-repellent agent (aqueous composition) having a solid content of 30% by weight. The composition of the resultant polymer was almost the same as the formulations of charged monomers.

The resultant polymer had a complex viscosity of 263 Pa-s at 70° C.

### Example 1

The fluorine-containing acrylic water- and oil-repellent agent (1 g) prepared by Preparative Example 1, an extender (Freepel 1225 available from BFGoodrich Specialty Chemicals) (3 g) and a 10% aqueous solution of sodium chloride (3 g) were diluted with pure water to give a test liquid (100 g). Four sheets of a wood pulp/polyester non-woven fabric (510 mm×205 mm) were immersed in this test liquid, was passed through a mangle, and dried at 100° C. for 30 seconds and treated at 120° C. for 30 seconds or at 170° C. for 2 minutes in a pin tenter. Then the water pressure resistance test, the IPR test and the water repellency test were conducted. The results are shown in Table 4.

### Example 2

The same treatment as in Example 1 was conducted except using the fluorine-containing acrylic water- and oil-repellent agent prepared in Preparative Example 2. Then the water pressure resistance test, the IPR test and the water repellency test were conducted. The results are shown in Table 4.

### Comparative Example 1

The same treatment as in Example 1 was conducted except using the fluorine-containing acrylic water- and oil-repellent agent prepared in Comparative Preparative Example 1. Then the water pressure resistance test, the IPR test and the water repellency test were conducted. The results are shown in Table 4.

### Comparative Example 2

The same treatment as in Example 1 was conducted except using the fluorine-containing acrylic water- and oil-repellent agent prepared in Comparative Preparative Example 2. Then the water pressure resistance test, the IPR test and the water repellency test were conducted. The results are shown in Table 4.

### Example 3

The fluorine-containing acrylic water- and oil-repellent agent (4 g) prepared by Preparative Example 1 was diluted with pure water to give a test liquid (100 g). Two sheets of a cotton (100%) twill woven fabric (510 mm×205 mm) were immersed in this test liquid, was passed through a mangle, and treated at 120° C. for 2 minutes or at 170° C. for 2 minutes in a pin tenter. Then the shower water repellency test and the oil repellency test were conducted. The results are shown in Table 5.

### Example 4

The same treatment as in Example 3 was conducted except using the fluorine-containing acrylic water- and oil-repellent agent prepared in Preparative Example 2. Then the shower water repellency test and the oil repellency test were conducted. The results are shown in Table 5.

### Comparative Example 3

The same treatment as in Example 3 was conducted except using the fluorine-containing acrylic water- and oil-repellent agent prepared in Comparative Preparative Example 3. Then the shower water repellency test and the oil repellency test were conducted. The results are shown in Table 5.

### Example 5

The fluorine-containing acrylic water- and oil-repellent agent (2 g) prepared by Preparative Example 1 was diluted with pure water to give a test liquid (100 g). Four sheets of a high-density polyester fabric (510 mm×205 mm) were immersed in this test liquid, was passed through a mangle, and treated at 120° C. for 2 minutes or at 150° C. for 2 minutes in a pin tenter. Then the water pressure resistance test, the oil repellency test and the water repellency test were conducted. The results are shown in Table 6.

### Comparative Example 4

The same treatment as in Example 5 was conducted except using the fluorine-containing acrylic water- and oil-repellent agent prepared in Comparative Preparative Example 3. Then the water pressure resistance test, the oil repellency test and the water repellency test were conducted. The results are shown in Table 6.

### Example 6

The fluorine-containing acrylic water- and oil-repellent agent (1 g) prepared by Preparative Example 1, an extender (Freepel 1225 available from BFGoodrich Specialty Chemicals) (3 g) and a 10% aqueous solution of sodium chloride (3 g) were diluted with pure water to give a test liquid (100 g). Four sheets of a wood pulp/polyester non-woven fabric (510 mm×205 mm) were immersed in this test liquid, was passed through a mangle, and dried at 100° C. for 30 seconds and treated at 120° C. for 30 seconds or at 170° C. for 2 minutes in a pin tenter. Then the water pressure resistance test, the IPR test and the water repellency test were conducted. The results are shown in Table 7.

### Comparative Example 5

The same treatment as in Example 6 was conducted except using the fluorine-containing acrylic water- and oil-repellent agent prepared in Comparative Preparative Example 3. Then the water pressure resistance test, the IPR test and the water repellency test were conducted. The results are shown in Table 7.

TABLE 4

| | | Water | | |
|---|---|---|---|---|
| | | pressure | | |
| | Cure | resistance | | Water |
| | temperature | (mm) | IPR (g) | repellency |
| Example 1 | 120° C. | 275 | 0.09 | 9 |
| Example 2 | 120° C. | 270 | 0.19 | 9 |
| Com. Ex. 1 | 120° C. | 272 | 0.70 | 9 |
| Com. Ex. 2 | 120° C. | 247 | 1.25 | 8 |
| Example 1 | 170° C. | 298 | 0.10 | 10 |
| Example 2 | 170° C. | 299 | 0.12 | 10 |
| Com. Ex. 1 | 170° C. | 295 | 0.11 | 9 |
| Com. Ex. 2 | 170° C. | 266 | 0.13 | 8 |

<Application Condition>
Mangle pressure: 4.0 kg/cm2
Mangle speed: 4 m/min
WPU %: 99%

Table 4 reveals that samples (Examples 1 and 2) having the complex viscosity of at most about 3,000 (at most 2,840) Pa-s at 70° C. desirably can give good performance.

TABLE 5

| | | Shower | |
|---|---|---|---|
| | Cure | water | Oil |
| | temperature | repellency | repellency |
| Example 3 | 120° C. | 90 | 7 |
| Example 4 | 120° C. | 80 | 5 |
| Com. Ex. 3 | 120° C. | 70+ | 7 |
| Example 3 | 170° C. | 90 | 7 |
| Example 4 | 170° C. | 90 | 7 |
| Com. Ex. 3 | 170° C. | 80 | 7 |

<Application Condition>
Mangle pressure: 4.0 kg/cm2
Mangle speed: 4 m/min
WPU %: 68%

TABLE 6

| | Cure | Water pressure | Oil | Water |
|---|---|---|---|---|
| | temperature | resistance (mm) | repellency | repellency |
| Example 5 | 120° C. | 351 | 5 | 3 |
| Com. Ex. 4 | 120° C. | 337 | 4 | 3 |
| Example 5 | 150° C. | 377 | 6 | 3 |
| Com. Ex. 4 | 150° C. | 343 | 6 | 3 |

<Application Condition>
Mangle pressure: 4.0 kg/cm2
Mangle speed: 4 m/min
WPU %: 71%

TABLE 7

| | | Water | | |
|---|---|---|---|---|
| | | pressure | | |
| | Cure | resistance | | Water |
| | temperature | (mm) | IPR (g) | repellency |
| Example 6 | 120° C. | 291 | 0.06 | 10 |
| Com. Ex. 5 | 120° C. | 269 | 0.53 | 10 |
| Example 6 | 170° C. | 318 | 0.09 | 10 |
| Com. Ex. 5 | 170° C. | 283 | 0.45 | 10 |

<Application Conditions>
Mangle pressure: 4.0 kg/cm2
Mangle speed: 4 m/min
WPU: 96%

Tables 5 to 7 reveal that the incorporation of crosslinkable monomer can exhibit excellent performances even at a low temperature.

FIG. 1 is the measurement result under a temperature rise of 5° C./min in a measurement temperature from 40° C. to 180° C. at a sample amount of 0.6 g and a frequency of 0.5 Hz. FIG. 1 shows that the polymer is crosslinked in Preparative Example 1.

FIG. 2 is the measurement result under a temperature rise of 5° C./min in a measurement temperature from 40° C. to 180° C. at a sample amount of 0.8 g and a frequency of 0.5 Hz. FIG. 2 shows that the increase of the amount of the chain transfer agent gives the decrease of the viscosity.

1. A fluorine-containing polymer comprising:
(a) a fluorine-containing monomer, and
(b) a crosslinkable monomer,
wherein the monomers (a) and (b) are polymerized in the presence of a chain transfer agent to produce the fluorine-containing polymer.

2. The fluorine-containing polymer according to claim 1, wherein the fluorine-containing monomer (a) is a fluorine-containing acrylate ester.

3. The fluorine-containing polymer according to claim 2, wherein the fluorine-containing acrylate ester is of the general formula:
CH₂═C(—X)—C(═O)—Y—Z—Rf (1)
wherein X is a hydrogen atom, an alkyl group having 1 to 21 carbon atoms, a fluorine atom, a chlorine atom, a bromine atom, a iodine atom, a CFX¹X² group (wherein X¹ and X² is a hydrogen atom, a fluorine atom, a chlorine atom, a bromine atom or a iodine atom), a cyano group, a linear or branched fluoroalkyl group having 1 to 21 carbon atoms, a substituted or unsubstituted benzyl group, or a substituted or unsubstituted phenyl group;
Y is —O—or —NH—;
Z is an aliphatic group having 1 to 10 carbon atoms, an aromatic or cycloaliphatic group having 6 to 18 carbon atoms, a —CH₂CH₂N(R¹)SO₂— group (in which R¹ is an alkyl group having 1 to 4 carbon atoms), a —CH₂CH(OZ¹)CH₂— group (in which Z¹ is a hydrogen atom or an acetyl group), a —(CH₂)ₘ—SO₂—(CH₂)ₙ— group or a
—(CH₂)ₘ—S—(CH₂)ₙ— group where m is 1 to 10 and n is 0 to 10; and
Rf is a linear or branched fluoroalkyl group having 1 to 6 carbon atoms.

4. The fluorine-containing polymer according to claim 3, wherein, in the fluorine-containing monomer (a), the Rf group is a perfluoroalkyl group.

5. The fluorine-containing polymer according to claim 1, wherein the crosslinkable monomer (b) is a fluorine-free monomer having at least two reactive groups and/or carbon-carbon double bonds.

6. The fluorine-containing polymer according to claim 1, which contains (c) a monomer other than the monomers (a) and (b).

7. The fluorine-containing polymer according to claim 6, wherein the monomer (c) is a non-crosslinkable monomer.

8. The fluorine-containing polymer according to claim 7, wherein the non-crosslinkable monomer is of the formula:
CH₂═CA¹COOA²
wherein A¹ is a hydrogen atom or a methyl group, and
A² is an alkyl group represented by CₙH₂ₙ₊₁ where n=1 to 30.

9. The fluorine-containing polymer according to claim 1, which has a complex viscosity of from 500 to 3,000 Pa-s at 70° C.

10. A method of producing a fluorine-containing polymer comprising (a) a fluorine-containing monomer, and (b) a crosslinkable monomer,
wherein the method comprises the monomers are polymerized in the presence of a chain transfer agent to give the fluorine-containing polymer.

11. The method according to claim 10, wherein the chain transfer agent is an alkyl mercaptan.

12. A water- and oil-repellent agent comprising the fluorine-containing polymer according to claim 1.

13. The water- and oil-repellent agent according to claim 11, which further contains an aqueous medium.

14. A method of treating a substrate, which comprises treating the substrate with the water- and oil-repellent agent according to claim 12.

15. A textile which is treated with the water- and oil-repellent agent according to claim 12.
